(19) United States
(12) Patent Application Publication
(10) Pub. No.: US 2024/0073148 A1
(43) Pub. Date: Feb. 29, 2024

(54) PROTOCOL DATA UNIT (PDU) SET BASED LOGICAL CHANNEL PRIORITIZATION

(71) Applicant: QUALCOMM Incorporated, San Diego, CA (US)

(72) Inventors: Mickael MONDET, Louannec (FR); Ozcan OZTURK, San Diego, CA (US); Sitaramanjaneyulu KANAMARLAPUDI, San Diego, CA (US); Ravi AGARWAL, San Diego, CA (US); Mohamed Atef Abdelazim SHEHATA, Lannion (FR); Peerapol TINNAKORNSRISUPHAP, San Diego, CA (US); Prashanth Haridas HANDE, San Diego, CA (US); Chih-Ping LI, San Diego, CA (US); Hyun Yong LEE, San Diego, CA (US); Ovidiu Constantin IACOBOAIEA, Chatillon (FR)

(21) Appl. No.: 17/822,671

(22) Filed: Aug. 26, 2022

(51) Int. Cl. H04L 47/24; H04L 47/32; H04W 28/02

(52) U.S. Cl. CPC H04L 47/2458; H04L 47/245; H04L 47/32; H04W 28/02; H04L 1/1812

(57) ABSTRACT

Certain aspects of the present disclosure provide a method for wireless communications by a node. The node receives a plurality of data packets belonging to a protocol data unit (PDU) set. Each of the plurality of data packets is associated with a dynamic priority. The node delivers the plurality of data packets to a lower layer, in accordance with the dynamic priority associated with each of the plurality of data packets.

### BACKGROUND

### Field of the Disclosure

Aspects of the present disclosure relate to wireless communications, and more particularly, to techniques for enhancements to a logical channel prioritization process to support protocol data unit (PDU) set based service flows.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a node, comprising: receiving a plurality of data packets belonging to a protocol data unit (PDU) set, wherein each of the plurality of data packets is associated with a dynamic priority; and delivering the plurality of data packets to a lower layer, in accordance with the dynamic priority associated with each of the plurality of data packets.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts example layer 2 (L2) architecture.

FIG. 6 depicts example bursts of protocol data unit (PDU) sets.

FIG. 7 depicts example mapping between different flows and channels.

FIG. 8 depicts a method for wireless communications by a node.

FIG. 9 depicts example mapping between PDU and PDU set based service flows and quality of service (QoS) flows.

FIG. 10 depicts example use case where a dynamic priority applies to all radio link control (RLC) service data units (SDUs), RLC PDUs, and segments of the RLC PDUs of PDU set based internet protocol (IP) packet flows.

FIG. 11 depicts example mapping between different flows and channels.

FIG. 12 depicts example communications device.

### DETAILED DESCRIPTION

Aspects of the present disclosure provide apparatuses, methods, processing systems, and computer-readable mediums for enhancements to a logical channel prioritization process to support protocol data unit (PDU) set based service flows.

An extended reality (XR) application generates and consumes in data units, which are larger than internet protocol (IP) packets (e.g., data packets). The data units are called PDU sets. For example, the IP packets generated by the XR application are grouped into the PDU sets. Although the data packets of each PDU set typically arrive at a receiver around a same time, however, in some cases, the data packets of each PDU set may not arrive at the same time. All data packets in a PDU sets may have same quality of service (QoS) requirements.

Current layer 2 (L2) procedures (e.g., a logical channel prioritization process, which prioritizes based on static priority associated with data packets) are configured and performed on basis of individual data packets (and associated QoS requirements), and not PDU sets. That is, different L2 procedures are applied on different data packets, and the different data packets maybe processed separately. However, in a PDU set, all data packets of the PDU set have same QoS requirements and have to be processed together. This is because if any data packet of the PDU set does not meet its QoS deadline, then remaining data packets of the PDU set become useless and the PDU set has to be discarded. Accordingly, there is a need for enhancements in the L2 procedures to support PDU set based scheduling (e.g., to manage processing (e.g., jointly or separately) of the data packets of the PDU set). For example, there is a need for enhancements to the logical channel prioritization process to support the PDU set based service flows.

The present application describes enhancements to a logical channel prioritization process to support PDU set based service flows. The enhancements may include moving from a static priority model to a dynamic priority model for data packets. For example, data packets belonging to a PDU set, which may be close to their associated delay budget will get a higher priority over other data packets (i.e., closer to the deadline, the higher the priority). The enhancements may further include discarding of data packets of the PDU set, when PDU set discard time expires.

Techniques for the enhancements to the logical channel prioritization process to support the PDU set based service flows may improve transmission process of the PDU sets in 5G new radio (NR) system. The application of the enhanced logical channel prioritization process may also meet QoS requirements of the PDU set based service flows.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

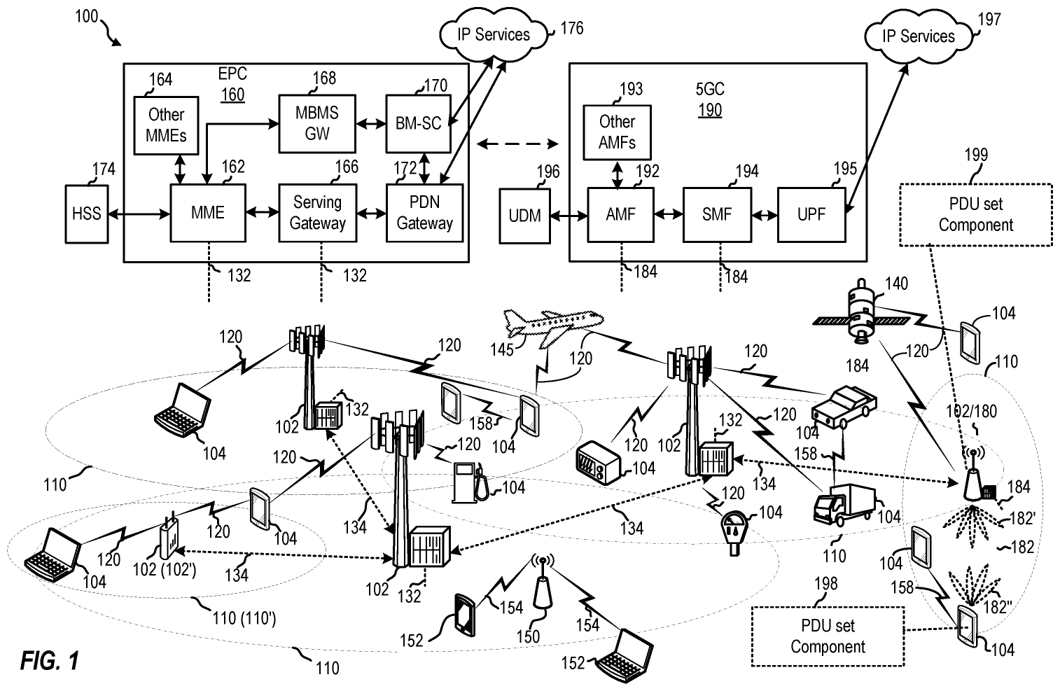

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

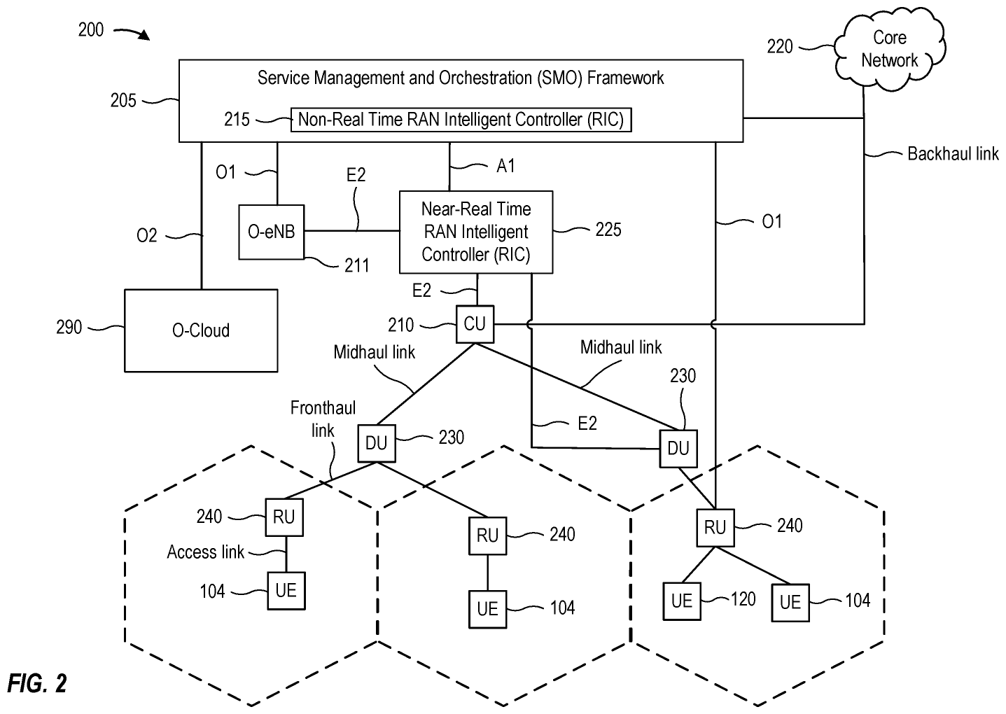

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (MC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

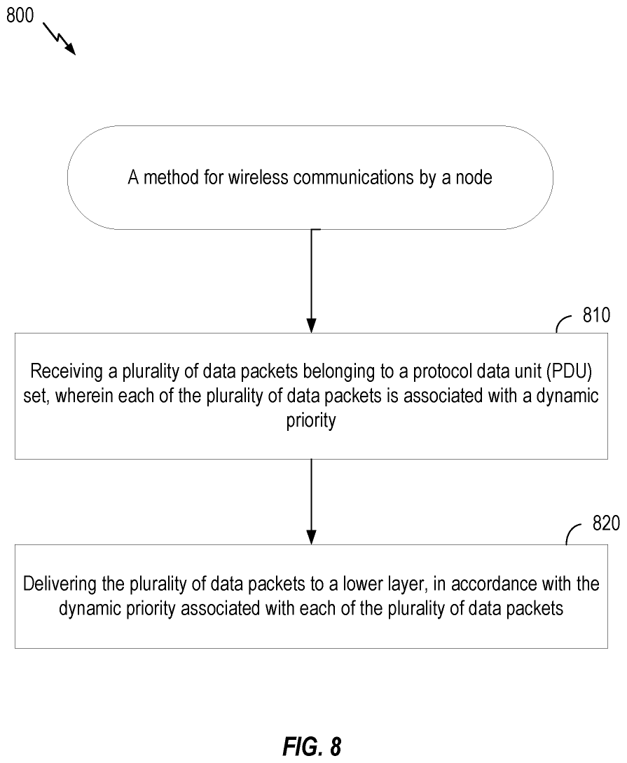

Wireless communication network 100 further includes protocol data unit (PDU) set component 198, which may be configured to perform operations 800 of FIG. 8. Wireless communication network 100 further includes PDU set component 199, which may be configured to perform operations 800 of FIG. 8.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT MC 225 and may be received at the SMO Framework 205 or the Non-RT MC 215 from non-network data sources or from network functions. In some examples, the Non-RT MC 215 or the Near-RT MC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

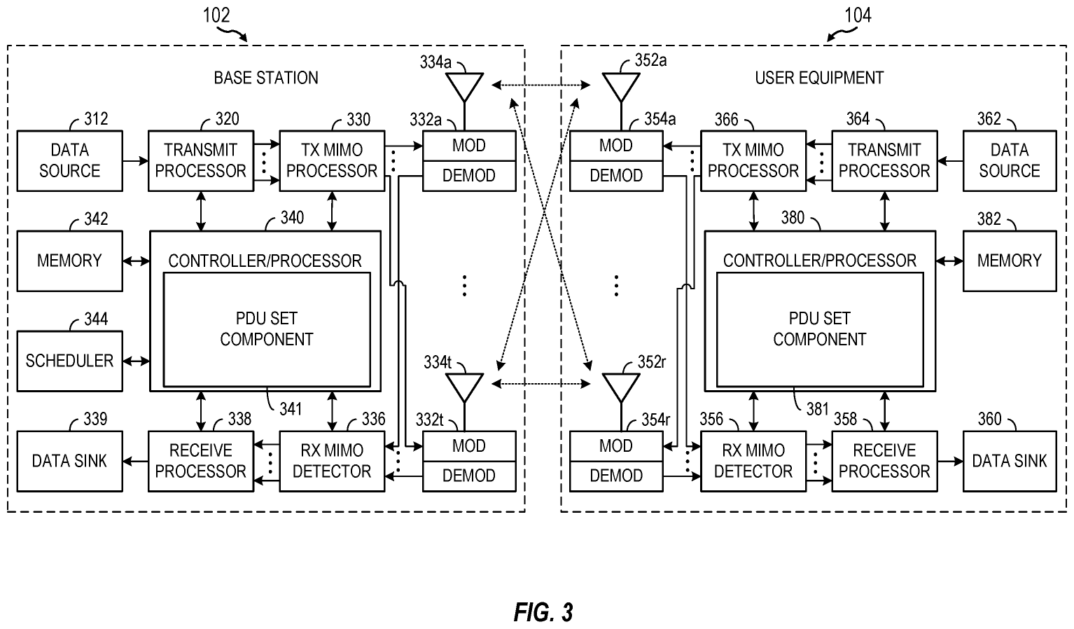

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes PDU set component 341, which may be representative of PDU set component 199 of FIG. 1. Notably, while depicted as an aspect of controller/processor 340, PDU set component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes PDU set component 381, which may be representative of PDU set component 198 of FIG. 1. Notably, while depicted as an aspect of controller/processor 380, PDU set component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

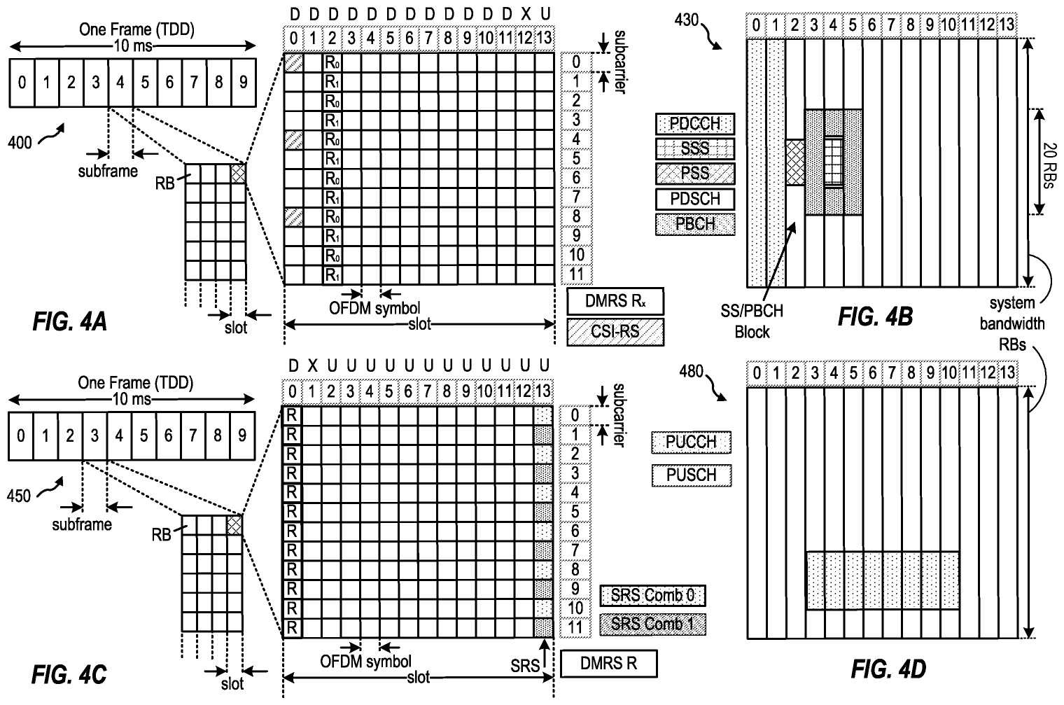

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of sub carriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}-15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Quality of Service (QoS)

Quality of service (QoS) refers to a measurement of overall performance of a service experienced by users of a network. To quantitatively measure QoS packet loss, bit rate, throughput, transmission delay, availability, etc. related aspects of the service are considered. QoS includes requirements on all aspects of a connection, such as service response time, loss, signal-to-noise ratio, crosstalk, echo, interrupts, frequency response, and/or loudness levels.

In 5G new radio (NR), QoS is enforced at a QoS flow level. Each QoS flow packets (e.g., data packets) are classified and marked using QoS flow identifier (QFI). For example, a first QoS flow is associated with video packets (e.g., Whatsapp video and Skype video) and a second QoS flow is associated with video streaming packets (e.g., YouTube video stream). The one or more QoS flows are mapped in an access network to one or more data radio bearers (DRBs). For example, a DRB transports packets of an evolved packet system (EPS) bearer between a user equipment (UE) and a network entity.

Within the 5G network, 5G QoS identifier (5QI) mechanism may be used in which packets are classified into different QoS classes. In this way, the QoS can be tailored to specific requirements. Each QoS class has its own assigned QoS characteristics (e.g., such as packet delay and packet loss). Accordingly, some packets can get better QoS than other packets.

The network entity maps individual QoS flows to one or more DRBs. A protocol data unit (PDU) session may contain multiple QoS flows and several DRBs. For example, the PDU session provides end-to-end user-plane connectivity between the UE and a specific data network through user-plane function (UPF). The PDU session supports one or more QoS flows, and a DRB transports the one or more QoS flows.

The network entity provides the UE with one or more QoS flow descriptions associated with the PDU session at the PDU session establishment or at the PDU session modification. Each QoS flow description may include a) a QFI; b) if the QoS flow is a guaranteed bit rate (GBR) QoS flow: 1) guaranteed flow bit rate (GFBR) for uplink, 2) GFBR for downlink, 3) maximum flow bit rate (MFBR) for uplink, 4) MFBR for downlink and/or 5) averaging window applicable for both uplink and downlink, or if the QoS flow is a non-GBR QoS flow: 1) reflective QoS attribute (RQA) in downlink and/or 2) additional QoS flow information; c) 5G QoS identifier (5QI) if the QFI is not the same as the 5QI of the QoS flow identified by the QFI; d) allocation and retention priority (ARP), and/or e) an EPS bearer identity (EBI) if the QoS flow can be mapped to an EPS bearer. All packets belonging to a specific QoS flow has a same 5QI.

The network entity provides the UE with QoS rules associated with the PDU session. The QoS rules may be provided at the PDU session establishment or at the PDU session modification. Each QoS rule includes an indication of whether the QoS rule is a default QoS rule, a QoS rule identifier (QRI), a QFI, a set of packet filters, and/or a precedence value.

### Example Layer 2 (L2) of New Radio (NR) Protocol Stock

New radio (NR) radio protocol stack has two categories: 1) control-plane stack, and 2) user-plane stack. If data corresponds to signaling or controlling message, then the data is sent through the control-plane. User data is sent through the user-plane.

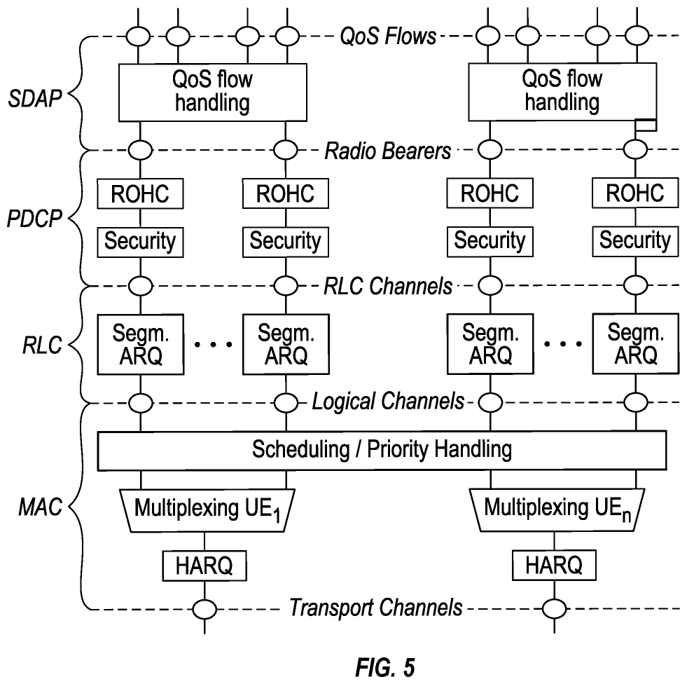

As illustrated in FIG. 5, user-plane protocol stock (e.g., layer 2 (L2)) of NR is split into sub layers such as a service data adaptation protocol (SDAP) layer, a packet data convergence protocol (PDCP) layer, a radio link control (RLC) layer, and a medium access control (MAC) layer. In NR, carrier aggregation is supported, and data for each carrier may be processed independently in the SDAP layer, the PDCP layer, the RLC layer and is multiplexed in the MAC layer.

The SDAP layer may perform mapping between a quality of service (QoS) flow (e.g., associated with one or more packets (e.g., protocol data units (PDUs)) and a data radio bearer (DRB) (e.g., due to QoS framework). The QoS flows may be PDU based service flows. The SDAP layer may also perform marking QoS flow ID (QFI) in both downlink and uplink packets (e.g., downlink due to reflective QoS and uplink due to QoS framework). A single protocol entity of SDAP is configured for each individual protocol data unit (PDU) session.

The PDCP layer may perform header compression and decompression of internet protocol (IP) data (e.g., robust header compression (ROHC)), maintain PDCP sequence numbers (SNs), perform in-sequence delivery of upper layer PDUs at re-establishment of lower layers, perform reordering and eliminate duplicates of lower layer service data units (SDUs), execute PDCP PDU routing for the case of split bearers, execute retransmission of lower layer SDUs, cipher and decipher control plane and user-plane data, perform integrity protection and integrity verification of control plane and user plane data, control timer-based discard of data, and perform security operations (e.g., ciphering, deciphering, integrity protection, integrity verification, etc.).

The RLC layer may operate in a plurality of modes of operation including transparent mode (TM), unacknowledged mode (UM), and acknowledged mode (AM). The RLC layer may perform transfer of upper layer PDUs error correction through automatic repeat request (ARQ) for AM data transfers, and segmentation and reassembly of RLC SDUs for UM and AM data transfers. The RLC layer may maintain SNs independent of the ones in PDCP for UM and AM data transfers. The RLC layer may perform resegmentation of RLC data PDUs for AM data transfers, detect duplicate data for AM data transfers, discard RLC SDUs for UM and AM data transfers, detect protocol errors for AM data transfers, and/or perform RLC re-establishment.

The MAC layer may perform mapping between logical channels and transport channels, multiplexing of MAC SDUs from one or more logical channels onto transport blocks (TB) to be delivered to a physical layer (PHY) via transport channels, de-multiplexing MAC SDUs to one or more logical channels from TB delivered from the PHY via the transport channels, scheduling information reporting, error correction through hybrid automatic repeat request (HARM), priority handling between UEs by means of dynamic scheduling, priority handling between logical channels of one UE by means of logical channel prioritization, and/or padding.

### Example Logical Channel Prioritization Process

For uplink, the process by which a user equipment (UE) creates a medium access control (MAC) protocol data unit (PDU) to transmit using allocated radio resources is fully standardized. This is to ensure that, for PDU based service flows, the UE satisfies quality of service (QoS) of each configured radio bearer. Based on uplink transmission resource grant message signaled on a physical downlink control channel (PDCCH), the UE may decide on an amount of data for each logical channel to be included in new MAC PDU, and, if necessary, also to allocate space for a MAC control element (MAC-CE).

In some cases, a logical channel prioritization process is applied when a new transmission is performed. One way to meet this purpose is to serve radio bearers in order of their priority. Following this principle, data from a logical channel of a highest priority is first to be included into a MAC PDU, followed by data from a logical channel of a next highest priority, continuing until a MAC PDU size allocated by a network entity is completely filled or there is no more data to transmit.

In some cases, radio resource control (RRC) may control scheduling of uplink data by signaling for each logical channel: priority (e.g., where an increasing priority value indicates a lower priority level), prioritized bit rate (PBR), and bucket size duration (BSD).

The UE may maintain a variable Bj for each logical channel j. Bj may be initialized to zero when the related logical channel is established, and incremented by the product PBR×transmission time interval (TTI) duration for each TTI, where PBR is prioritized bit rate of logical channel j. However, the value of Bj can never exceed the bucket size and if the value of Bj is larger than the bucket size of logical channel j, it shall be set to the bucket size. The bucket size of a logical channel is equal to PBR×BSD, where PBR and BSD are configured by upper layers.

### Example Protocol Data Unit (PDU) Set

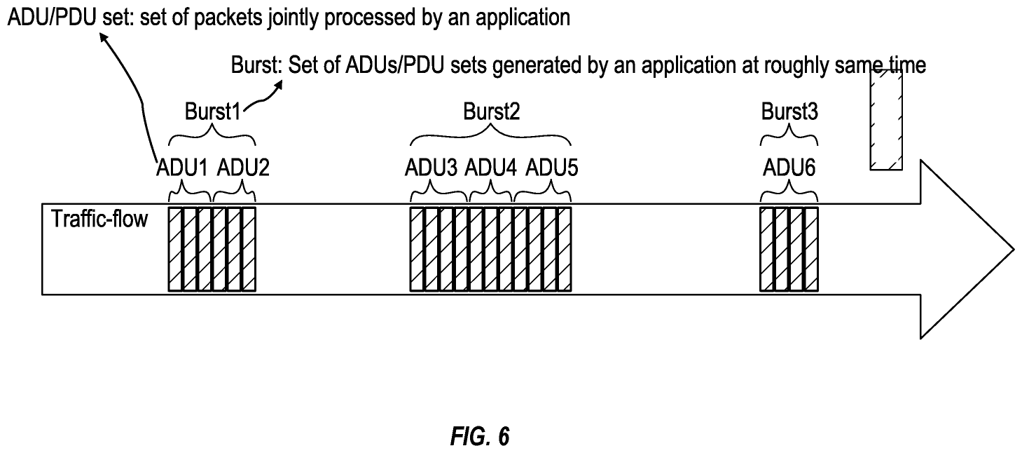

An extended reality (XR) application may include a virtual reality (VR) application, an augmented reality (AR) application, and/or a mixed reality (MR) application. The XR application generates and consumes in data units, which are larger (e.g., in size) than internet protocol (IP) packets (e.g., data packets). For example, one video frame per burst, slices of a video frame per burst, etc. These data units are called application data units (ADUs). The ADU is also known as a protocol data unit (PDU) set. As illustrated in FIG. 6, in the XR application, a PDU set may correspond to a set of data packets that are jointly processed and a burst may correspond to a set of PDU sets generated around a same time.

The IP packets generated by the XR application are grouped into the PDU sets. Although the data packets of each PDU set typically arrive at a receiver around a same time, however, in some cases, the data packets of each PDU set may not arrive at the same time. In some cases, all data packets in a PDU set may have same quality of service (QoS) requirements. The QoS requirements of the PDU set may be associated with PDU set specific QoS parameters, such as, PDU set delay budget, PDU set discard time, PDU set error rate, PDU set content policy, and/or PDU set content ratio.

There may be two types of PDU sets. One type of a PDU set is called a type-A PDU set, and another type of the PDU set is called a type-B PDU set. With regards to the type-A PDU set (e.g., all or nothing PDU set), if any data packet in the type-A PDU set is lost (e.g., during transmission) or misses a deadline (e.g., associated with its QoS requirements), then remaining data packets in the type-A PDU set become useless. With regards to the type-B PDU set, a reception of the type-B PDU set is considered to be successful when a decoding criterion is met (e.g., a predetermined number of data packets or bytes of the type-B PDU set are received).

### Example Quality of Service (QoS) Model and Conventional Logical Channel Prioritization Process

As noted above, quality of service (QoS) is enforced at a QoS flow level. For example, data packets associated with different service flows (e.g., protocol data unit (PDU) based service flows) are classified and marked using QoS flow identifier (QFI) based on QoS rules. In one example, the QoS rules may be explicitly signaled to a user equipment (UE). In another example, the QoS rules may be preconfigured in the UE. In another example, the UE may derive the QoS rules.

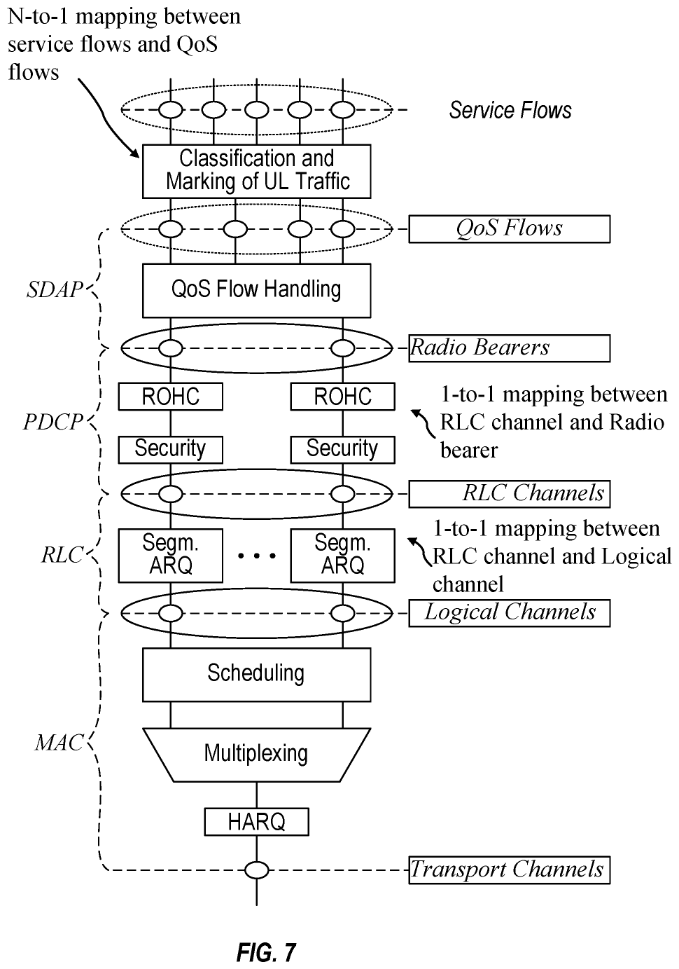

As illustrated in FIG. 7, based on the QoS rules, N to 1 mapping is performed between the services flows and QoS flows. After the mapping is performed, there may be different QoS flows. For example, a first QoS flow may be associated with a first set of data packets (e.g., video packets) from the different service flows and a second QoS flow may be associated with a second set of data packets (e.g., video streaming packets) from the different service flows.

As further illustrated in FIG. 7, the QoS flows are mapped in an access network to data radio bearers (DRBs). For example, N to 1 mapping may be performed between the QoS flows and the DRBs. As further illustrated in FIG. 7, one to one mapping is performed between the DRBs and radio link control (RLC) channels, and between the RLC channels and logical channels.

As noted above, a medium access control (MAC) layer may perform mapping between the logical channels and transport channels, and priority handling between the logical channels is based on a logical channel prioritization process.

Current layer 2 (L2) procedures (e.g., the logical channel prioritization process) are configured and performed on basis of individual data packets (and associated QoS requirements), and not PDU sets. That is, different L2 procedures are applied on different data packets, and the different data packets maybe processed separately. However, in a PDU set, all data packets of the PDU set have same QoS requirements and have to be processed together. This is because if any data packet of the PDU set does not meet its QoS deadline, then remaining data packets of the PDU set become useless and the PDU set has to be discarded.

Accordingly, there is a need for enhancements in the L2 procedures to support PDU set based scheduling (e.g., to manage processing (e.g., jointly or separately) of the data packets of the PDU set). For example, there is a need for enhancements to the logical channel prioritization process to support the PDU set based service flows (e.g., to improve transmission of the PDU sets in 5G new radio (NR) system).

### Aspects Related to Protocol Data Unit (PDU) Set Based Logical Channel Prioritization

Aspects of the present disclosure provide apparatuses, methods, processing systems, and computer-readable mediums for enhancements to a logical channel prioritization process to support protocol data unit (PDU) set based service flows. The enhancements may include moving from a static priority model to a dynamic priority model for data packets. For example, data packets belonging to a PDU set, which may be close to their associated delay budget will get a higher priority over other data packets (i.e., closer to the deadline, the higher the priority). The enhancements may further include discarding of data of the PDU set, which may be beyond PDU set content policy or when PDU set discard time expires.

Techniques for the enhancements to the logical channel prioritization process to support the PDU set based service flows may improve transmission of the PDU sets in 5G new radio (NR) system. The application of the enhanced logical channel prioritization process can meet quality of service (QoS) requirements of the PDU set based service flows. The techniques proposed herein may be understood with reference to the FIGS. 8-11.

FIG. 8 illustrates example operations 800 for wireless communication. In certain aspects, the operations 800 may be performed, for example, by a node such as a user equipment (UE) (e.g., such as UE 104 in wireless communication network 100 of FIG. 1). The operations 800 may be implemented as software components that are executed and run on one or more processors (e.g., controller/processor 380 of FIG. 3). Further, transmission and reception of signals by the UE in the operations 800 may be enabled, for example, by one or more antennas (e.g., antennas 352 of FIG. 3). In certain aspects, the transmission and/or reception of signals by the UE may be implemented via a bus interface of one or more processors (e.g., the controller/processor 380) obtaining and/or outputting signals.

In certain aspects, the operations 800 may be performed, for example, by a node such as a network entity (e.g., such as BS 102 in wireless communication network 100 of FIG. 1). The operations 800 may be implemented as software components that are executed and run on one or more processors (e.g., controller/processor 340 of FIG. 3). Further, transmission and reception of signals by the network entity in the operations 800 may be enabled, for example, by one or more antennas (e.g., antennas 334 of FIG. 3). In certain aspects, the transmission and/or reception of signals by the network entity may be implemented via a bus interface of one or more processors (e.g., the controller/processor 340) obtaining and/or outputting signals.

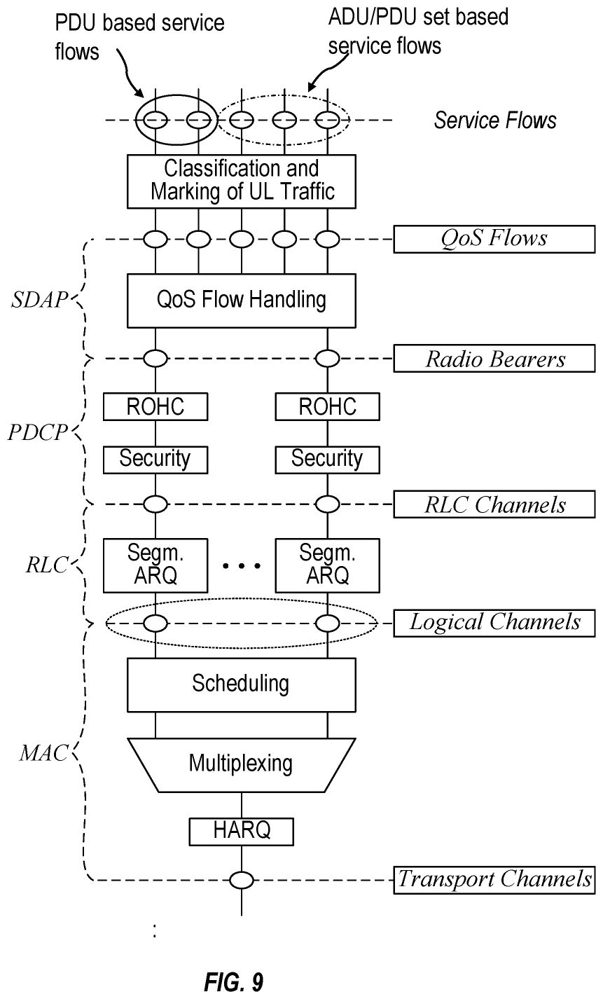

The operations 800 begin, at 810, by receiving a plurality of data packets belonging to a PDU set where each of the plurality of data packets is associated with a dynamic priority. For example, each internet protocol (IP) packet of uplink PDU set based service flow (as illustrated in FIG. 9) is associated with the dynamic priority.

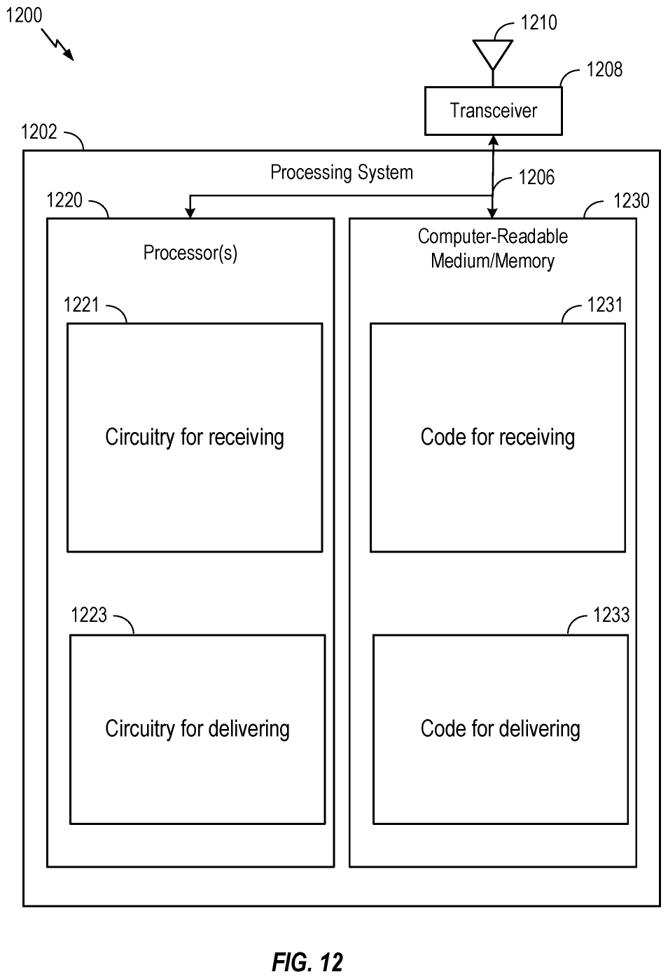

In one example, the node may receive the plurality of data packets belonging to the PDU set, using antenna(s) and/or receiver/transceiver components of UE 104 shown in FIG. 1 or FIG. 3 and/or of the apparatus shown in FIG. 12. In another example, the node may receive the plurality of data packets belonging to the PDU set, using antenna(s) and/or receiver/transceiver components of BS 102 shown in FIG. 1 or FIG. 3 and/or of the apparatus shown in FIG. 12.

Referring back to FIG. 8, at 820, the node delivers the plurality of data packets to a lower layer, in accordance with the dynamic priority associated with each of the plurality of data packets. For example, when an application (e.g., extended reality (XR) application) may deliver several IP packets at approximately a same time, one dynamic priority is applied to a set of IP packets.

In one example, the node may deliver the plurality of data packets to the lower layer, using antenna(s) and/or transmitter/transceiver components of UE 104 shown in FIG. 1 or FIG. 3 and/or of the apparatus shown in FIG. 12. In another example, the node may deliver the plurality of data packets to the lower layer, using antenna(s) and/or transmitter/transceiver components of BS 102 shown in FIG. 1 or FIG. 3 and/or of the apparatus shown in FIG. 12.

In certain aspects, the node may update the dynamic priority associated with each of the plurality of data packets using a medium access control (MAC) layer. For example, the MAC layer may handle (i.e., increase or decrease) the dynamic priority associated with each of the plurality of data packets.

In certain aspects, a data packet of the plurality of data packets is embedded into a radio link control (RLC) service data unit (SDU). The RLC SDU may be segmented into a plurality of RLC PDUs. Each RLC PDU of the plurality of RLC PDUs may be segmented into a plurality of RLC segments. For example, an IP packet is embedded into an RLC SDU, which can be segmented into several RLC PDUs. The RLC PDUs may further be segmented for retransmissions.

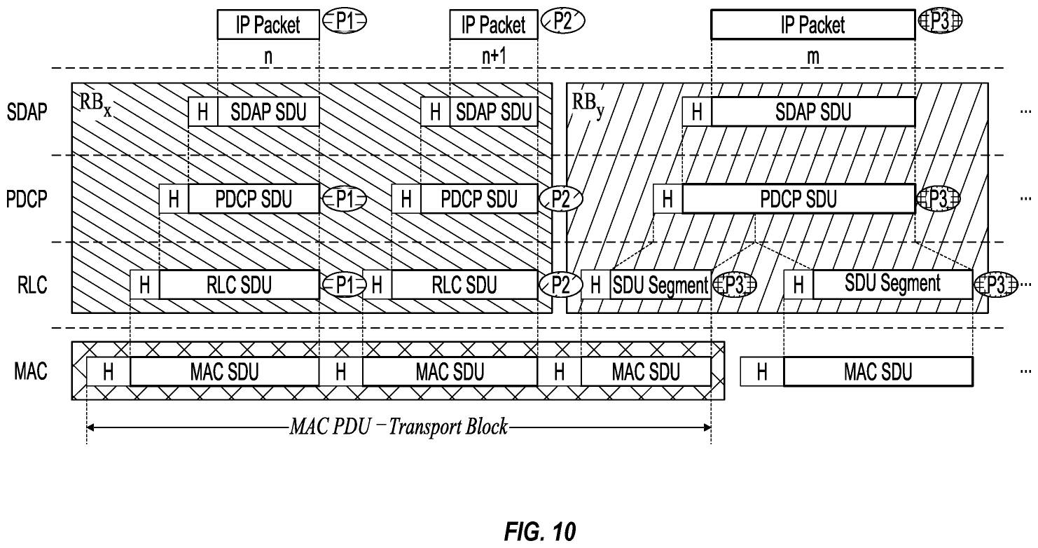

In certain aspects, the node may apply the dynamic priority of the data packet to all RLC SDUs, RLC PDUs and RLC segments of the data packet. For example, as illustrated in FIG. 10, the dynamic priority applies to all RLC SDUs, RLC PDUs and segments of RLC PDUs of a PDU set based IP packet.

In certain aspects, when a new transmission is performed, a logical channel prioritization process is performed in four steps. In a first step, update amount of tokens in a bucket ‘Bj’ for each logical channel. In a second step, select logical channels that can be allocated resources. In a third step, allocate resources to the selected logical channels (e.g., for which Bj>0 is in a decreasing priority order). In a fourth step, if any resource remains, allocate resources to the selected logical channels in the decreasing priority order.

In certain aspects, the node may update the dynamic priority associated with each of the plurality of data packets for a new transmission. For example, when the new transmission is performed, the dynamic priority of PDU set based data (e.g., RLC SDUs, RLC PDUs and segments) is updated before the third step of the logical channel prioritization process. The update may be performed either at a beginning (like a ‘step 0’) of the logical channel prioritization process, or just before the third step of the logical channel prioritization process, to avoid updating priorities of the data that belong to logical channels that are not selected in the second step of the logical channel prioritization process.

In certain aspects, transmission of PDU set based data may not jeopardize other data such as signaling radio bearer (SRB).

In certain aspects, the node may configure a minimum priority value and a maximum priority value for a logical channel. For example, the logical channel may be configured with a minimum ‘prio_min’ priority value and a maximum ‘prio_max’ priority value, with prio_min priority value being less than or equal to prio_max priority value. Note that the lower the value is, the higher the priority is.

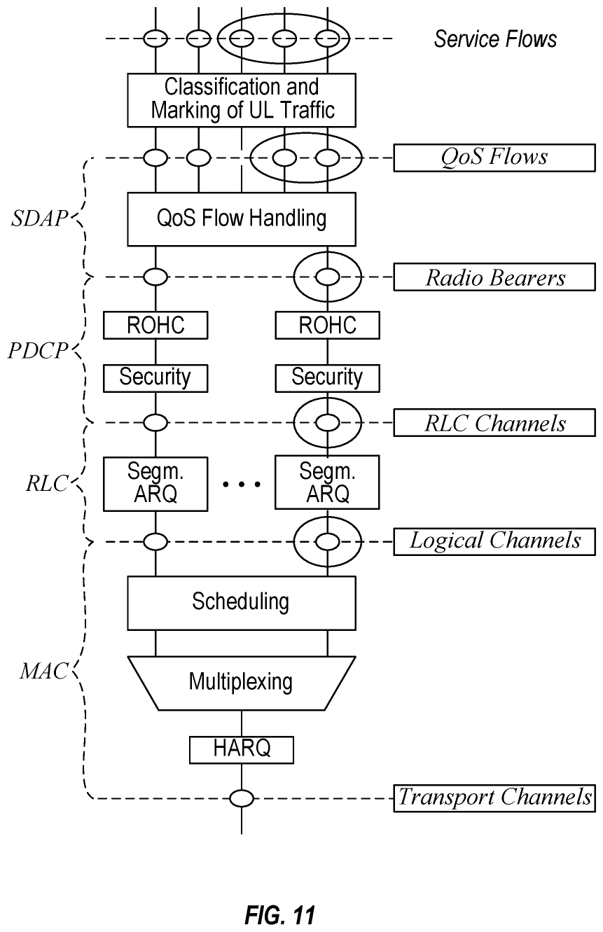

In certain aspects, the node may map a data packet of the plurality of data packets to the logical channel, and a value of the dynamic priority of the data packet is between the minimum priority value and the maximum priority value. For example, as illustrated in FIG. 11, the dynamic priority of data (e.g., which may belong to any PDU based service flow) that is mapped onto the logical channel configured with ‘prio_min’ priority value and ‘prio_max’ priority value may be in a range (prio_min . . . prio_max).

In certain aspects, the node may determine the dynamic priority associated with each of the plurality of data packets. For example, the node may determine the dynamic priority associated with each of the plurality of data packets, based on a delay budget for the PDU set and/or an arrival time for the PDU set.

In certain aspects, the node may provide by a non-access stratum (NAS) layer the delay budget for the PDU set to a MAC layer. For example, the delay budget may be provided by the NAS layer to the MAC layer for each PDU set based quality of service (QoS) service flow upon (re-)configuration.

In certain aspects, the node may provide by a service data adaptation protocol (SDAP) layer the arrival time for the PDU set to a MAC layer. For example, the PDU set arrival time may be provided by the SDAP layer to the MAC layer, upon delivery from an application of a first IP Packet of the PDU set.

In certain aspects, the node may calculate a time from an arrival time of the PDU set. For example, whenever the dynamic priority of a data packet that belongs to the PDU set is updated, the MAY layer may calculate time ‘T_adu’ since the arrival time of the PDU set.

In certain aspects, the node may determine the dynamic priority for each of the plurality of data packets based on the calculated time. In one example, the dynamic priority is equal to a minimum priority value, when the calculated time is more than a delay budget for the PDU set (i.e., if T_adu>PDU set delay budget=>dynamic priority=prio_min). In another example, the dynamic priority is equal to a sum of a maximum priority value and another value when the calculated time is less than a delay budget for the PDU set (i.e., dynamic priority=prio_max+(prio_min−prio_max)*(T_adu/PDU set delay budget).

In certain aspects, multiple service flows may be mapped onto a same logical channel. Some service flows may be PDU-based and some service flows may be PDU-set based. Each of these service flows data packet may have its own dynamic priority. The priority of the data packet that belongs to the PDU set-based service flow may be determined per above-noted techniques.

In certain aspects, the node may map each of the plurality of data packets to a logical channel. The node may determine the dynamic priority associated with each of the plurality of data packets, based on a priority of the logical channel. The node may select a highest value of the priority for the logical channel from all priority values. For example, the priority of the logical channel may be a highest one among a static priority (e.g., if at least one PDU based service flow is there) and all dynamic priorities.

In certain aspects, some PDU based service flows may be latency sensitive and benefit from dynamic priorities associated with PDU set-based service flows.

In certain aspects, each PDU is associated with a dynamic priority. In some cases, a dynamic priority of PDU based service flow may be calculated from packet delay budget (PDB), instead of PDU set based delay budget.

In certain aspects, the node may determine the PDU set has met a content policy associated with the PDU set. In one example, the node may receive an RLC status report and/or a hybrid automatic repeat request (HARQ) feedback indicating that the PDU set has met the content policy associated with the PDU set. In another example, the node may determine the PDU set has met the content policy based on the RLC status report and/or the HARQ feedback.

In certain aspects, the node may discard data packets of the plurality of data packets that have not been transmitted, in response to the determining that the PDU set has met the content policy. For example, when a UE may determine that the PDU set has met its PDU set content policy (e.g., through RLC status reports and/or HARQ feedbacks), the UE may discard all data of the PDU set that is still waiting for transmission.

In certain aspects, PDU set discard time is an upper bound for a time that the PDU set has been waiting for transmission at a sender device of a link layer protocol before being discarded. In some cases, all data of the PDU set that is still waiting for transmission, when the PDU set discard time expires, can be discarded as this data is useless to a receiver device.

In certain aspects, the node may determine that a discard timer of the PDU set has expired. The node may discard data packets of the plurality of data packets that have not been transmitted, in response to the determining that the discard timer of the PDU set has expired. For example, when the discard time of the PDU set expires, a UE may discard all data of the PDU set that is still waiting for transmission.

### Example Communications Device

FIG. 12 depicts aspects of an example communications device 1200. In some aspects, communications device 1200 is a UE, such as UE 104 described above with respect to FIGS. 1 and 3.

The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes one or more processors 1220. In various aspects, the one or more processors 1220 may be representative of one or more of receive processor 358, transmit processor 364, TX MIMO processor 366, and/or controller/processor 380, as described with respect to FIG. 3. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the operations 800 described with respect to FIG. 8, or any aspect related to it. Note that reference to a processor performing a function of communications device 1200 may include one or more processors performing that function of communications device 1200.

In the depicted example, computer-readable medium/memory 1230 stores code (e.g., executable instructions) for receiving 1231 comprising code for receiving a plurality of data packets belonging to a PDU set where each of the plurality of data packets is associated with a dynamic priority, and code for delivering 1233 comprising code for delivering the plurality of data packets to a lower layer in accordance with the dynamic priority associated with each of the plurality of data packets. Processing of the code 1231-1233 may cause the communications device 1200 to perform the operations 800 described with respect to FIG. 8, or any aspect related to it.

The one or more processors 1220 include circuitry configured to implement (e.g., execute) the code stored in the computer-readable medium/memory 1230, including circuitry for receiving 1221 comprising circuitry for receiving a plurality of data packets belonging to a PDU set where each of the plurality of data packets is associated with a dynamic priority, and circuitry for delivering 1223 comprising circuitry for delivering the plurality of data packets to a lower layer in accordance with the dynamic priority associated with each of the plurality of data packets. Processing with circuitry 1221-1223 may cause the communications device 1200 to perform the operations 800 described with respect to FIG. 8, or any aspect related to it.

Various components of the communications device 1200 may provide means for performing the operations 800 described with respect to FIG. 8, or any aspect related to it. For example, means for transmitting, sending or outputting for transmission may include the transceivers 354 and/or antenna(s) 352 of the UE 104 illustrated in FIG. 3 and/or transceiver 1208 and antenna 1210 of the communications device 1200 in FIG. 12. Means for receiving or obtaining may include the transceivers 354 and/or antenna(s) 352 of the UE 104 illustrated in FIG. 3 and/or transceiver 1408 and antenna 1410 of the communications device 1200 in FIG. 12.

In some aspects, communications device 1200 is a network entity, such as BS 102 described above with respect to FIGS. 1 and 3. In various aspects, one or more processors 1220 may be representative of one or more of receive processor 338, transmit processor 320, TX MIMO processor 330, and/or controller/processor 340, as described with respect to FIG. 3.

### Example Clauses

Implementation examples are described in the following numbered clauses:
Clause 1: A method for wireless communications by a node, comprising: receiving a plurality of data packets belonging to a protocol data unit (PDU) set, wherein each of the plurality of data packets is associated with a dynamic priority; and delivering the plurality of data packets to a lower layer, in accordance with the dynamic priority associated with each of the plurality of data packets.
Clause 2: The method alone or in combination with the first clause, further comprising updating the dynamic priority associated with each of the plurality of data packets using a medium access control (MAC) layer.
Clause 3: The method alone or in combination with the first clause, wherein: a data packet of the plurality of data packets is embedded into a radio link control (RLC) service data unit (SDU); the RLC SDU is segmented into a plurality of RLC PDUs; and each RLC PDU is segmented into a plurality of RLC segments.
Clause 4: The method alone or in combination with the third clause, wherein the delivering further comprises applying the dynamic priority of the data packet to all RLC SDUs, RLC PDUs and RLC segments of the data packet.
Clause 5: The method alone or in combination with the first clause, further comprising updating the dynamic priority associated with each of the plurality of data packets for a new transmission.
Clause 6: The method alone or in combination with the first clause, further comprising configuring a minimum priority value and a maximum priority value for a logical channel.
Clause 7: The method alone or in combination with the sixth clause, further comprising mapping a data packet of the plurality of data packets to the logical channel, wherein a value of the dynamic priority of the data packet is between the minimum priority value and the maximum priority value.
Clause 8: The method alone or in combination with the first clause, further comprising determining the dynamic priority associated with each of the plurality of data packets.
Clause 9: The method alone or in combination with the eighth clause, wherein the determining comprises determining the dynamic priority associated with each of the plurality of data packets based on a delay budget for the PDU set and an arrival time for the PDU set.
Clause 10: The method alone or in combination with the ninth clause, further comprising providing by a non-access stratum (NAS) layer the delay budget for the PDU set to a medium access control (MAC) layer.
Clause 11: The method alone or in combination with the ninth clause, further comprising providing by a service data adaptation protocol (SDAP) layer the arrival time for the PDU set to a medium access control (MAC) layer.
Clause 12: The method alone or in combination with the fifth clause, further comprising: calculating a time from an arrival time of the PDU set; and determining the dynamic priority for each of the plurality of data packets based on the calculated time.
Clause 13: The method alone or in combination with the twelfth clause, wherein the dynamic priority is equal to a minimum priority value when the calculated time is more than a delay budget for the PDU set.
Clause 14: The method alone or in combination with the twelfth clause, wherein the dynamic priority is equal to a sum of a maximum priority value and another value when the calculated time is less than a delay budget for the PDU set.
Clause 15: The method alone or in combination with the eighth clause, further comprising: mapping each of the plurality of data packets to a logical channel; the determining comprises determining the dynamic priority associated with each of the plurality of data packets based on a priority of the logical channel; and selecting a highest value of the priority for the logical channel from all priority values.
Clause 16: The method alone or in combination with the first clause, wherein each PDU is associated with a dynamic priority.
Clause 17: The method alone or in combination with the first clause, further comprising: determining the PDU set has met a content policy associated with the PDU set; and discarding data packets of the plurality of data packets that have not been transmitted, in response to the determining that the PDU set has met the content policy.
Clause 18: The method alone or in combination with the seventeenth clause, wherein the determining further comprises: receiving at least one of: a radio link control (RLC) status report or a hybrid automatic repeat request (HARQ) feedback indicating that the PDU set has met the content policy associated with the PDU set; and determining the PDU set has met the content policy based on the at least one of: the RLC status report or the HARQ feedback.
Clause 19: The method alone or in combination with the first clause, further comprising: determining that a discard timer of the PDU set has expired; and discarding data packets of the plurality of data packets that have not been transmitted, in response to the determining that the discard timer of the PDU set has expired.
Clause 20: The method alone or in combination with the first clause, wherein the node is a user equipment (UE).
Clause 21: The method alone or in combination with the first clause, wherein the node is a network entity.
Clause 22: An apparatus, comprising: a memory comprising executable instructions; and a processor configured to execute the executable instructions and cause the apparatus to perform a method in accordance with any one of Clauses 1-21.
Clause 23: An apparatus, comprising means for performing a method in accordance with any one of Clauses 1-21.
Clause 24: A non-transitory computer-readable medium comprising executable instructions that, when executed by a processor of an apparatus, cause the apparatus to perform a method in accordance with any one of Clauses 1-21.
Clause 25: A computer program product embodied on a computer-readable storage medium comprising code for performing a method in accordance with any one of Clauses 1-21.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A node configured for wireless communications, comprising:
a memory comprising computer-executable instructions; and
a processor configured to execute the computer-executable instructions and cause the node to:
receive a plurality of data packets belonging to a protocol data unit (PDU) set, wherein each of the plurality of data packets is associated with a dynamic priority; and
deliver the plurality of data packets to a lower layer, in accordance with the dynamic priority associated with each of the plurality of data packets.

2. The node of claim 1, wherein the processor is further configured to execute the computer-executable instructions and cause the node to: update the dynamic priority associated with each of the plurality of data packets using a medium access control (MAC) layer.

3. The node of claim 1, wherein:
a data packet of the plurality of data packets is embedded into a radio link control (RLC) service data unit (SDU);
the RLC SDU is segmented into a plurality of RLC PDUs; and
each RLC PDU is segmented into a plurality of RLC segments.

4. The node of claim 3, wherein the deliver further comprises apply the dynamic priority of the data packet to all RLC SDUs, RLC PDUs and RLC segments of the data packet.

5. The node of claim 1, wherein the processor is further configured to execute the computer-executable instructions and cause the node to: update the dynamic priority associated with each of the plurality of data packets for a new transmission.

6. The node of claim 1, wherein the processor is further configured to execute the computer-executable instructions and cause the node to: configure a minimum priority value and a maximum priority value for a logical channel.

7. The node of claim 6, wherein the processor is further configured to execute the computer-executable instructions and cause the node to: map a data packet of the plurality of data packets to the logical channel, wherein a value of the dynamic priority of the data packet is between the minimum priority value and the maximum priority value.

8. The node of claim 1, wherein the processor is further configured to execute the computer-executable instructions and cause the node to: determine the dynamic priority associated with each of the plurality of data packets.

9. The node of claim 8, wherein the determine comprises determine the dynamic priority associated with each of the plurality of data packets based on a delay budget for the PDU set and an arrival time for the PDU set.

10. The node of claim 9, wherein the processor is further configured to execute the computer-executable instructions and cause the node to: provide by a non-access stratum (NAS) layer the delay budget for the PDU set to a medium access control (MAC) layer.

11. The node of claim 9, wherein the processor is further configured to execute the computer-executable instructions and cause the node to: provide by a service data adaptation protocol (SDAP) layer the arrival time for the PDU set to a medium access control (MAC) layer.

12. The node of claim 5, wherein the processor is further configured to execute the computer-executable instructions and cause the node to:
calculate a time from an arrival time of the PDU set; and
determine the dynamic priority for each of the plurality of data packets based on the calculated time.

13. The node of claim 12, wherein the dynamic priority is equal to a minimum priority value when the calculated time is more than a delay budget for the PDU set.

14. The node of claim 12, wherein the dynamic priority is equal to a sum of a maximum priority value and another value when the calculated time is less than a delay budget for the PDU set.

15. The node of claim 8, wherein the processor is further configured to execute the computer-executable instructions and cause the node to:
map each of the plurality of data packets to a logical channel;
the determine comprises determine the dynamic priority associated with each of the plurality of data packets based on a priority of the logical channel; and
select a highest value of the priority for the logical channel from all priority values.

16. The node of claim 1, wherein each PDU is associated with a dynamic priority.

17. The node of claim 1, wherein the processor is further configured to execute the computer-executable instructions and cause the node to:
determine the PDU set has met a content policy associated with the PDU set; and
discard data packets of the plurality of data packets that have not been transmitted, in response to the determining that the PDU set has met the content policy.

18. The node of claim 17, wherein the determine further comprises:
receive at least one of: a radio link control (RLC) status report or a hybrid automatic repeat request (HARQ) feedback indicating that the PDU set has met the content policy associated with the PDU set; and
determine the PDU set has met the content policy based on the at least one of: the RLC status report or the HARQ feedback.

19. The node of claim 1, wherein the processor is further configured to execute the computer-executable instructions and cause the node to:
determine that a discard timer of the PDU set has expired; and
discard data packets of the plurality of data packets that have not been transmitted, in response to the determining that the discard timer of the PDU set has expired.

20. The node of claim 1, wherein the node is a user equipment (UE).

21. The node of claim 1, wherein the node is a network entity.

22. A method for wireless communications by a node, comprising:
receiving a plurality of data packets belonging to a protocol data unit (PDU) set, wherein each of the plurality of data packets is associated with a dynamic priority; and
delivering the plurality of data packets to a lower layer, in accordance with the dynamic priority associated with each of the plurality of data packets.

23. The method of claim 22, further comprising updating the dynamic priority associated with each of the plurality of data packets using a medium access control (MAC) layer.

24. The method of claim 22, wherein:
a data packet of the plurality of data packets is embedded into a radio link control (RLC) service data unit (SDU);
the RLC SDU is segmented into a plurality of RLC PDUs; and
each RLC PDU is segmented into a plurality of RLC segments.

25. The method of claim 24, wherein the delivering further comprises applying the dynamic priority of the data packet to all RLC SDUs, RLC PDUs and RLC segments of the data packet.

26. The method of claim 22, further comprising updating the dynamic priority associated with each of the plurality of data packets for a new transmission.

27. The method of claim 22, further comprising configuring a minimum priority value and a maximum priority value for a logical channel.

28. The method of claim 27, further comprising mapping a data packet of the plurality of data packets to the logical channel, wherein a value of the dynamic priority of the data packet is between the minimum priority value and the maximum priority value.

29. A node configured for wireless communications, comprising: a memory comprising computer-executable instructions; and a processor configured to execute the computer-executable instructions and cause the node to:
receive a plurality of data packets belonging to a protocol data unit (PDU) set, wherein each of the plurality of data packets is associated with a dynamic priority; and
deliver the plurality of data packets to a lower layer, in accordance with the dynamic priority associated with each of the plurality of data packets.

30. A node configured for wireless communications, comprising:
means for receiving a plurality of data packets belonging to a protocol data unit (PDU) set, wherein each of the plurality of data packets is associated with a dynamic priority; and
means for delivering the plurality of data packets to a lower layer, in accordance with the dynamic priority associated with each of the plurality of data packets.
